(19) United States
(12) Patent Application Publication
(10) Pub. No.: US 2016/0302462 A1
(43) Pub. Date: Oct. 20, 2016

(54) BIOMASS FORMULATION

(71) Applicant: DSM IP ASSETS B.V., Heerlen (NL)

(72) Inventors: Daniel GREENFELL-LEE, Kaiseraugst (CH); Christian SCHÄFER, Kaiseraugst (CH); James TREGANOWAN, Kaiseraugst (CH); Carlos SANTOS, Kaiseraugst (CH)

(21) Appl. No.: 15/101,692

(22) PCT Filed: Dec. 5, 2014
(86) PCT No.: PCT/EP2014/076735

§ 371 Date: Jun. 3, 2016

Related U.S. Application Data
(60) Provisional application No. 61/912,933, filed on Dec. 6, 2013.

(51) Int. Cl. C12N 1/20; A23K 20/179; A23K 20/174

(52) U.S. Cl. CPC A23L 33/10; A23L 29/284; A23L 33/15; A23K 20/179; A23K 20/174

(57) ABSTRACT

The present invention relates to a solid formulation comprising a carotenoid producing source bioorganism, which is storage stable, as well as the process of production of this formulation.

The present invention relates to a solid formulation comprising a carotenoid producing source bioorganism, as well as process of production of this formulation, and its use in feed products (or premixes).

Carotenoids are organic pigments ranging in color from yellow to red that are naturally produced by certain bioorganisms, including photosynthetic organisms (e.g., plants, algae, cyanobacteria), and some fungi. Carotenoids are responsible for the orange color of carrots, as well as the pink in flamingos and salmon, and the red in lobsters and shrimp. Animals, however, cannot produce carotenoids and must receive them through their diet. Carotenoid pigments (e.g., (β-carotene and astaxanthin) are used industrially as ingredients for food and feed stocks, both serving a nutritional function and enhancing consumer acceptability. For example, astaxanthin is widely used in salmon aquaculture to provide the pink/red pigmentation characteristic of their wild counterparts. Some carotenoids provide potential health benefits, for example as vitamin A precursors or antioxidants (see, for example, Jyonouchi et al., Nutr, Cancer 16:93, 1991; Giovannucci et al., Natl. Cancer Inst. 87:1767, 1995; Miki, Pure Appl. Chem 63:141, 1991; Chew et al., Anticancer Res. 19:1849, 1999; Wang et al., Antimicrob. Agents Chemother. 44:2452, 2000). Some carotenoids such as β-carotene, lycopene, astaxanthin, zeaxanthin and lutein are currently sold as nutritional supplements.

Natural carotenoids can either be obtained by extraction of plant material or by microbial synthesis; but, only a few plants are widely used for commercial carotenoid production and the productivity of carotenoid synthesis in these plants is relatively low. Microbial production of carotenoids is a more attractive production route. Examples of carotenoid-producing microorganisms (=bioorganism) include: algae (Haematococcus pluvialis, sold under the tradename NatuRose(™) by Cyanotech Corp., Kailua-Kona, Hi.; Dunaliella sp.; Thraustochytrium sp.), yeast (Phaffia rhodozyma, recently renamed as Xanthophyllomyces dendrorhous; Labyrinthula sp.; Saccharomyces cerevisiae; and Yarrowia lipolytica), and bacteria (Paracoccus marcusii, Bradyrhizobium, Rhodobacter sp., Brevibacterium, Escherichia coli and Methylomonas sp.). Additionally, recombinant production of carotenoids is also possible, since the genes involved in carotenoid biosynthesis are well-known and have been heterologously expressed in a variety of host cells (e.g., E. coli, Candida utilis, Saccharomyces cerevisiae, Methylomonas sp.). Thus far, few of these demonstrations are suitable to produce a carotenoid product in significant quantities in a cost-effective manner for industrial use.

The present invention relates to the formulation of source bioorganisms, which produces carotenoids. Usually these source biorganism produce carotenoid(s), retinolic compound(s) or other small molecule lipophilic agent(s) and accumulate the produced compound to greater than or equal to 1% of its dry cell weight.

Presently, the carotenoid is obtained as follows:

After the source bioorganism has finished the production of the carotenoid, the carotenoid is isolated and then further formulated into the desired application form.

Surprisingly we have found a way to formulate the source bioorganism as such (without isolating the carotenoid), which result in stable solid (dry) formulations. This new process of production (or formulation) is a practical and effective way for obtaining such formulations.

Therefore the present invention relates to a solid formulation (SF) comprising
(i) 25 to 75 weight-% (wt-%), based on the total weight of the solid formulation, of at least one source bioorganism producing carotenoid(s), retinolic compound(s) or other small molecule lipophilic agent(s), and
(ii) 25 to 75 wt-%, based on the total weight of the solid formulation, of at least one hydrocolloid, and
(iii) optionally 0.1 to 10 wt-%, based on the total weight of the solid formulation, of at least one antioxidant and
(iv) optionally 5 to 20 wt-%, based on the total weight of the solid formulation, of at least one auxiliary agent.

It is clear that the percentages in one solid formulation always add up to 100%.

The source biorganism produces carotenoid(s), retinolic compound(s) or other small molecule lipophilic agent(s) and accumulate the produced compound to greater than or equal to 1% of its dry cell weight.

The term “source bioorganism”, as used herein, includes, for example, animal, mammalian, insect, plant, fungal, yeast, algal, bacterial, cyanobacterial, archaebacterial and protozoal bioorganisms.

Therefore the present invention also relates to a solid formulation (SF1), which is solid formulation (SF), wherein the source bioorganism is chosen from the group consisting of animal, mammalian , insect, plant, fungal, yeast, algal, bacterial, cyanobacterial, archaebacterial and protozoal bioorganisms.

The source bioorganism, which produce carotenoids, can be natural (as to be found in nature) or it can be modified.

Suitable source bioorganisms are known from the prior art, i.e. from WO2006102342 (especially in [0037]-[0042]).

Among these very suitable source bioorganisms (which are naturally oleaginous organisms) are yeast or fungi of genera including, but not limited to, Blakeslea, Candida, Cryptococcus, Cunninghamella, Lipomyces, Mortierella, Mucor, Phycomyces, Pythium, Rltodosporidium, Rliodotorula, Trichosporon, and Yarrowia. In certain particular embodiments, organisms of species that include, but are not limited to, Blakeslea frispora, Candida pulcherrima, C. revkaufi, C. tropicalis, Cryptococcus curvatus, Cunninghamella echinulata, C. elegans, C. japonica, Lipomyces starkeyi, L. lipoferus, Mortierella alpina, M. isabellina, M. ramanniana, M. vinacea, Mucor circinelloides, Phycomyces blakesleanus, Pythium irregulare, Rhodosporidium toruloides, Rhodotorula glutinis, R. gracilis, R. graminis, R. mucilaginosa, R pinicola, Trichosporon pullans, T. cutaneum, and Yarrowia lipolytica are used.

Therefore the present invention also relates to a solid formulation (SF2), which is solid formulation (SF) or (SF1), wherein the source bioorganism is chosen from the group consisting of Blakeslea, Candida, Cryptococcus, Cunninghamella, Lipomyces, Mortierella, Mucor, Phycomyces, Pythium, Rltodosporidium, Rliodotorula, Trichosporon, and Yarrowia, preferably chosen from the group consisting of Blakeslea frispora, Candida pulcherrima, C. revkaufi, C. tropicalis, Cryptococcus curvatus, Cunninghamella echinulata, C. elegans, C. japonica, Lipomyces starkeyi, L. lipoferus, Mortierella alpina, M. isabellina, M. ramanniana, M. vinacea, Mucor circinelloides, Phycomyces blakesleanus, Pythium irregulare, Rhodosporidium toruloides, Rhodotorula glutinis, R. gracilis, R. graminis, R. mucilaginosa, R pinicola, Trichosporon pullans, T. cutaneum, and Yarrowia lipolytica.

Among these very suitable source bioorganisms (which are naturally non-oleaginous organisms) are also yeast or fungi of genera including Aspergillus, Botrytis, Cercospora, Fusarium (Gibberella), Kluyveromyces, Neurospora, Penicillium, Pichia (Hansenula), Puccinia, Saccharomyces, Sclerotium, Trichoderma, and Xanthophyllomyces (Phaffia); in some embodiments, the organism is of a species including, but not limited to, Aspergillus nidulans, A. niger, A. terreus, Botrytis cinerea, Cercospora nicotianae, Fusarium fujikuroi {Gibberella zeae), Kluyveromyces lactis, K. lactis, Neurospora crassa, Pichia pastoris, Puccinia distincta, Saccharomyces cerevisiae, Sclerotium rolfsii, Trichoderma reesei, and Xanthophyllomyces dendrorhous (Phaffia rhodozyma).

Therefore the present invention also relates to a solid formulation (SF2′), which is solid formulation (SF) or (SF1), Aspergillus, Botrytis, Cercospora, Fusarium (Gibberella), Kluyveromyces, Neurospora, Penicillium, Pichia (Hansenula), Puccinia, Saccharomyces, Sclerotium, Trichoderma, and Xanthophyllomyces (Phaffia); in some embodiments, the organism is of a species including, but not limited to, Aspergillus nidulans, A. niger, A. terreus, Botrytis cinerea, Cercospora nicotianae, Fusarium fujikuroi {Gibberella zeae), Kluyveromyces lactis, K. lactis, Neurospora crassa, Pichia pastoris, Puccinia distincta, Saccharomyces cerevisiae, Sclerotium rolfsii, Trichoderma reesei, and Xanthophyllomyces dendrorhous (Phaffia rhodozyma)

The term “carotenoid” is understood in the art to refer to a structurally diverse class of pigments derived from isoprenoid pathway intermediates. The commitment step in carotenoid biosynthesis is the formation of phytoene from geranylgeranyl pyrophosphate. Carotenoids can be acyclic or cyclic, and may or may not contain oxygen, so that the term carotenoids include both carotenes and xanthophylls. In general, carotenoids are hydrocarbon compounds having a conjugated polyene carbon skeleton formally derived from the five-carbon compound IPP, including triterpenes (C₃₀ diapocarotenoids) and tetraterpenes (C₄₀ carotenoids) as well as their oxygenated derivatives and other compounds that are, for example, C₃₅, C₅₀, C₆₀, C₇₀, C₈₀ in length or other lengths. Many carotenoids have strong light absorbing properties and may range in length in excess of C₂₀₀₋ C₃₀ diapocarotenoids typically consist of six isoprenoid units joined in such a manner that the arrangement of isoprenoid units is reversed at the center of the molecule so that the two central methyl groups are in a 1,6-positional relationship and the remaining non-terminal methyl groups are in a 1,5-positional relationship. Such C₃₀ carotenoids may be formally derived from the acyclic C₃₀H₄₂ structure, having a long central chain of conjugated double bonds, by: (i) hydrogenation (ii) dehydrogenation, (iii) cyclization, (iv) oxidation, (v) esterification/glycosylation, or any combination of these processes. C₄₀ carotenoids typically consist of eight isoprenoid units joined in such a manner that the arrangement of isoprenoid units is reversed at the center of the molecule so that the two central methyl groups are in a 1,6-positional relationship and the remaining non-terminal methyl groups are in a 1,5- positional relationship. Such C₄₀ carotenoids may be formally derived from the acyclic C₄₀H₅₆ structure, having a long central chain of conjugated double bonds, by (i) hydrogenation, (ii) dehydrogenation, (iii) cyclization, (iv) oxidation, (v) esterification/glycosylation, or any combination of these processes. The class of C₄₀ carotenoids also includes certain compounds that arise from rearrangements of the carbon skeleton, or by the (formal) removal of part of this structure. More than 600 different carotenoids have been identified in nature.

Carotenoids include but are not limited to: antheraxanthin, adonirubin, adonixanthin, astaxanthin, canthaxanthin, capsorubrin, β-cryptoxanthin, α-carotene, β-carotene, β,ψ-carotene, δ-carotene, ε-carotene, echinenone, 3-hydroxyechinenone, 3′-hydroxyechinenone, γ-carotene, ψ-carotene, 4-keto-γ-carotene, ζ-carotene, α-cryptoxanthin, deoxyflexixanthin, diatoxanthin, 7,8-didehydroastaxanthin, didehydrolycopene, fucoxanthin, fucoxanthinol, isorenieratene, β-isorenieratene, lactucaxanthin, lutein, lycopene, myxobactone, mimulaxanthin, neoxanthin, neurosporene, hydroxyneurosporene, peridinin, phytoene, rhodopin, rhodopin glucoside, rhodoxanthin, 4-keto-rubixanthin, siphonaxanthin, spheroidene, spheroidenone, spirilloxanthin, torulene, 4-keto-torulene, 3-hydroxy-4-keto-torulene, uriolide, uriolide acetate, violaxanthin, zeaxanthin-β-diglucoside, zeaxanthin, and C₃₀ carotenoids. Additionally, carotenoid compounds include derivatives of these molecules, which may include hydroxy-, methoxy-, oxo-, epoxy-, carboxy-, or aldehydic functional groups. Further, included carotenoid compounds include ester (e.g., glycoside ester, fatty acid ester, acetylation) and sulfate derivatives (e.g., esterified xanthophylls). Most preferred in the context of the present invention are zeaxanthin and acetylated zeaxanthin.

Therefore the present invention also relates to a solid formulation (SF3), which is solid formulation (SF), (SF1), (SF2) or (SF2′), wherein the source bioorganism is producing a carotenoid chosen from the groups consisting of antheraxanthin, adonirubin, adonixanthin, astaxanthin, canthaxanthin, capsorubrin, β-cryptoxanthin, α-carotene, β-carotene, β,ψ-carotene, δ-carotene, ε-carotene, echinenone, 3-hydroxyechinenone, 3′-hydroxyechinenone, γ-carotene, ψ-carotene, 4-keto-γ-carotene, ζ-carotene, α-cryptoxanthin, deoxyflexixanthin, diatoxanthin, 7,8-didehydroastaxanthin, didehydrolycopene, fucoxanthin, fucoxanthinol, isorenieratene, β-isorenieratene, lactucaxanthin, lutein, lycopene, myxobactone, mimulaxanthin, neoxanthin, neurosporene, hydroxyneurosporene, peridinin, phytoene, rhodopin, rhodopin glucoside, rhodoxanthin, 4- keto-rubixanthin, siphonaxanthin, spheroidene, spheroidenone, spirilloxanthin, torulene, 4- keto-torulene, 3-hydroxy-4-keto-torulene, uriolide, uriolide acetate, violaxanthin, zeaxanthin-β-diglucoside, zeaxanthin, and C₃₀ carotenoids,as well as derivatives of these molecules (most preferred in the context of the present invention are zeaxanthin and acetylated zeaxanthin).

Carotenoids produced according to the present invention can be utilized in any of a variety of applications, for example exploiting their biological or nutritional properties (e.g., anti-oxidant, etc.) and/or their pigment properties. For example, carotenoids may be used in pharmaceuticals (see, for example, Bertram, Nutr. Rev. 57:182, 1999; Singh et al., Oncology 12:1643, 1998; Rock, Pharmacol. Titer. 75:185, 1997; Edge et al, J. Photochem Photobiol 41 :189, 1997; U.S. Patent Application 2004/0116514; U.S. Patent Application 2004/0259959), food supplements (see, for example, Koyama et al, J. Photochem Photobiol 9:265, 1991 ; Bauernfeind, Carotenoids as colorants and vitamin A precursors, Academic Press, NY, 1981 ; U.S. Patent Application 2004/0115309; U.S. Patent Application 2004/0234579), electro-optic applications, animal feed additives (see, for example, Krinski, Pure Appl. Chem. 66:1003, 1994; Polazza et al., Meth. Enzymol. 213 :403, 1992), cosmetics (as anti-oxidants and/or as cosmetics, including fragrances; see for example U.S. Patent Application 2004/0127554), etc. Carotenoids produced in accordance with the present invention may also be used as intermediates in the production of other compounds (e.g., steroids, etc.).

As examples of pharmaceutical and/or health applications astaxanthin and/or esters thereof may be useful in the treatment of inflammatory diseases, asthma, atopic dermatitis, allergies, multiple myeloma, arteriosclerosis, cardiovascular disease, liver disease, cerebrovascular disease, thrombosis, neoangiogenesis-related diseases, including cancer, rheumatism, diabetic retinopathy; macular degeneration and brain disorder, hyperlipidemia, kidney ischemia, diabetes, hypertension, tumor proliferation and metastasis; and metabolic disorders. Additionally, carotenoids and astaxanthin may be useful in the prevention and treatment of fatigue, for improving kidney function in nephropathy from inflammatory diseases, as well as prevention and treatment of other life habit-related diseases. Still further, astaxanthin has been found to play a role as inhibitors of various biological processes, including interleukin inhibitors, phosphodiesterase inhibitors inhibitors, phospholipase A2 inhibitors, cyclooxygenase-2 inhibitors, matrix metalloproteinase inhibitors, capillary endothelium cell proliferation inhibitors, lipoxygenase inhibitors. See, e.g., Japanese Publication No. 2006022121, published 20060126(JP Appl No. 2005-301156 filed 20051017); Japanese Publication No. 2006016408, published 20060119(JP Appl No. 2005-301155 filed 20051017); Japanese Publication No. 2006016409, published 20060119(JP Appl No. 2005-301157 filed 20051017); Japanese Publication No. 2006016407, published 20060119(JP Appl No. 2005-301153 filed 20051017); Japanese Publication No. 2006008717, published 20060112(JP Appl No. 2005-301151 filed 20051017); Japanese Publication No. 2006008716, published 20060112(JP Appl No. 2005-301150 filed 20051017); Japanese Publication No. 2006008720, published 20060112(JP Appl No. 2005-301158 filed 20051017); Japanese Publication No. 2006008719, published 20060112(JP Appl No. 2005-301154 filed 20051017); Japanese Publication No. 2006008718, published 20060112(JP Appl No. 2005-301152 filed 20051017); Japanese Publication No. 2006008713, published 20060112(JP Appl No. 2005-301147 filed 20051017); Japanese Publication No. 2006008715, published 20060112(JP Appl No. 2005-301149 filed 20051017); Japanese Publication No. 2006008714, published 20060112(JP Appl No. 2005-301148 filed 20051017); and Japanese Publication No. 2006008712, published 20060112 (JP Appl No. 2005-301146 filed 20051017).

The solid formulation comprises 25-75 wt-%, based on the total weight of the solid formulation, of the at least one source bioorganism. Preferably 25-70 wt-%, more preferably 30-70 wt-%, based on the total weight of the solid formulation, of the at least one source bioorganism.

Therefore the present invention also relates to a solid formulation (SF4), which is solid formulation (SF), (SF1), (SF2), (SF2′) or (SF3), wherein the solid formulation comprises 25-70 wt-%, preferably 30-70 wt-%, based on the total weight of the solid formulation, of the at least one source bioorganism.

In addition to the carotenoid producing source bioorganism, the formulation according to the present invention also comprises at least one hydrocolloid.

The term “hydrocolloid” is defined as a colloid system wherein the colloid particles are hydrophilic polymers dispersed in water. A hydrocolloid has colloid particles spread throughout water, and depending on the quantity of water available that can take place in different states, e.g., gel or sol (liquid). Hydrocolloids can be either irreversible (single-state) or reversible. For example, agar, a reversible hydrocolloid of seaweed extract, can exist in a gel and solid state, and alternate between states with the addition or elimination of heat.

Many hydrocolloids are derived from natural sources (plants or animals). For example, agar-agar and carrageenan are extracted from seaweed, gelatin is produced by hydrolysis of proteins of bovine and fish origins, and pectin is extracted from citrus peel and apple pomace.

Gelatin dessert like Jell-O is made from gelatin powder, another effective hydrocolloid. Hydrocolloids are employed in food mainly to influence texture or viscosity (e.g., a sauce). Hydrocolloid-based medical dressings are used for skin and wound treatment.

Other main hydrocolloids are agar-agar, carrageenan, gelatin, pectin, xanthan gum, gum arabic, guar gum, locust bean gum, cellulose derivatives as carboxymethyl cellulose, alginate, lignosulfonate, plant proteins (such as soy protein isolate or lupin protein isolates) and starch (also modified starches such as OSA-modified starches.

Therefore the present invention also relates to a solid formulation (SF5), which is solid formulation (SF), (SF1), (SF2), (SF2′), (SF3) or (SF4), wherein the solid formulation comprises at least one hydrocolloid chosen from the group consisting of agar-agar, carrageenan, gelatin, pectin, xanthan gum, gum arabic, guar gum, locust bean gum, cellulose derivatives as carboxymethyl cellulose, alginate, lignosulfonate, plant proteins (such as soy protein isolate or lupin protein isolates) and starch (also modified starches such as OSA-modified starches.

The solid formulation comprises 25-75 wt-%, based on the total weight of the solid formulation, of the at least one hydrocolloid. Preferably 30-75 wt-%, more preferably 30-70 wt-%, based on the total weight of the solid formulation, of the at least one hydrocolloid.

Therefore the present invention also relates to a solid formulation (SF6), which is solid formulation (SF), (SF1), (SF2), (SF2′), (SF3), (SF4) or (SF5), wherein the solid formulation comprises 30-75 wt-%, preferably 30-70 wt-%, based on the total weight of the solid formulation, of the at least one hydrocolloid.

Given the sensitivity of carotenoids generally to oxidation, many embodiments of the invention employ antioxidant(s) (e.g., tocopherols; vitamin C; ascorbyl palmitate; ethoxyquin; vitamin E, BHT, BHA, TBHQ, etc, or combinations thereof) during and/or after carotenoid isolation. Alternatively or additionally, microencapsulation, for example with proteins, may be employed to add a physical barrier to oxidation and/or to improve handling (see, for example, U.S. Patent Application 2004/0191365).

Therefore, solid formulation can comprise at least one antioxidant. When one or more antioxidants are used, then in an amount of 0.1-10 wt-%, based on the total weight of the solid formulation, preferably 0.5-8 wt-%, more preferably 0.5-5 wt-%.

Therefore the present invention also relates to a solid formulation (SF7), which is solid formulation (SF), (SF1), (SF2), (SF2′), (SF3), (SF4), (SF5) or (SF6), wherein the solid formulation comprises of 0.1-10 wt-%, based on the total weight of the solid formulation, preferably 0.5-8 wt-%, more preferably 0.5-5 wt-%, of at least one antioxidant.

Therefore the present invention also relates to a solid formulation (SF8), which is solid formulation (SF7), wherein the at least one antioxidant is chosen from the group consisting of tocopherols, vitamin C, ascorbyl palmitate, ethoxyquin, vitamin E, BHT, BHA and TBHQ.

Furthermore the formulation according to the present invention can also comprise at least one auxiliary agent.

Such auxiliary agents can be useful for the formulation by further improving its properties, such as physical stability, storage stability, visual perception, etc. Auxiliaries can also be useful for the application in the food or feed product by improving the property of these compositions, physical stability, storage stability, visual perception, controlled release in the GI-tract, pH control, etc.

The concentration of these auxiliaries can vary, depending on the use of these auxiliaries.

These auxiliary agents are usually present in an amount of 5 wt-% to 20 wt-%, based on the total weight of the solid formulation, preferably 5 wt-% to 15 wt-%,

Therefore the present invention also relates to a solid formulation (SF9), which is solid formulation (SF), (SF1), (SF2), (SF2′), (SF3), (SF4), (SF5), (SF6), (SF7) or (SF8), wherein the solid formulation comprises of 5-20 wt-%, based on the total weight of the solid formulation, preferably 5-15 wt-%, of at least one auxiliary agent.

Usually the solid formulation has a carotenoid content of at least 0.1 wt-%, based on the total weight of the solid formulation. Usually the solid formulation has a carotenoid content of up to at least 20 wt-%, based on the total weight of the solid formulation.

The content can vary. So it is obvious that the content of carotenoid can be lower as indicated above as well as higher. A preferred range is 0.1-20 wt-%, based on the total weight of the solid formulation, more preferred 0.2-15 wt-%.

Therefore the present invention also relates to a solid formulation (SF10), which is solid formulation (SF), (SF1), (SF2), (SF2′), (SF3), (SF4), (SF5), (SF6), (SF7), (SF8) or (SF9), wherein the solid formulation comprises of 5-20 wt-%, based on the total weight of the solid formulation, preferably 5-15 wt-%, of at least one carotenoid.

Furthermore the present invention also relates to a process of production of the new solid formulations, which are described above.

The process for the preparation of the solid formulation is the following:
The harvested fermentation broth may or may not be pasteurized
the bioorganism is harvested from the fermentation broth by standard solid/liquid separation techniques (e.g. centrifugation) and the concentrated bioorganism is resuspended in an aqueous medium (e.g. deionized water); afterwards
the supernatant is discarded; afterwards
the bioorganism pellet is optionally re-suspended in an aqueous medium (e.g. deionized water) to a dry matter content (% solids) similar to the original fermentation broth and again concentrated by solid/liquid separation (this step can be repeated as needed); afterwards
optionally, the biomass may be ruptured (e.g. by means physical, chemical, enzymatic, or a combination thereof); afterwards
optionally at least one antioxidant is added; afterwards
at least one hydrocolloid is added as well as optionally at least one auxiliary agent; afterwards
the solution is dried (e.g. by spray drying).

Therefore the present invention relates to process of production (PP) of a solid formulation as described above (SF), (SF1), (SF2), (SF2′), (SF3), (SF4), (SF5), (SF6), (SF7), (SF8), (SF9) and/or (SF10) comprising the following steps (the specific order of which may be altered):
(a) optionally pasteurizing the harvested fermentation broth; and
(b) harvesting the bioorganism from the fermentation broth (e.g. by centrifugation) and re-suspending the biorganism pellet in an aqueous medium, and
(c) discarding the supernatant; and
(d) optionally resuspending the bioorganism pellet in an aqueous medium and again harvesting the bioorganism pellet, and
(e) optionally rupturing the biomorganisms (e.g. by milling); and
(f) optionally adding at least one antioxidant is added; and
(g) adding at least one hydrocolloid as well as adding optionally at least one auxiliary agent; and
(h) drying the solution.

The solid formulations (SF), (SF1), (SF2), (SF2′), (SF3), (SF4), (SF5), (SF6), (SF7), (SF8), (SF9) and/or (SF10) can be used as such or they can be used to produce other formulationa (for the use as food, feed, pharmaceutical, personal care products).

Therefore the present invention also relates to the use of at least one solid formulation (SF), (SF1), (SF2), (SF2′), (SF3), (SF4), (SF5), (SF6), (SF7), (SF8), (SF9) and/or (SF10) in the production of food products, feed products, pharmaceutical products and/or personal care products.

Furthermore the present invention also relates to the use of at least one solid formulation (SF), (SF1), (SF2), (SF2′), (SF3), (SF4), (SF5), (SF6), (SF7), (SF8), (SF9) and/or (SF10) in the production of a premix for food products, feed products, pharmaceutical products and/or for personal care products.

Furthermore the present invention also relates to food products, feed products, pharmaceutical products and/or personal care products comprising at least one solid formulation (SF), (SF1), (SF2), (SF2′), (SF3), (SF4), (SF5), (SF6), (SF7), (SF8), (SF9) and/or (SF10).

Furthermore the present invention also relates premixes (for food products, feed products, pharmaceutical products and/or for personal care products) comprising at least one solid formulation (SF), (SF1), (SF2), (SF2′), (SF3), (SF4), (SF5), (SF6), (SF7), (SF8), (SF9) and/or (SF10).

The following examples serve to illustrate the invention.

All parts and percentages are related to weight.

### EXAMPLES

The following examples have been prepared as described in the description.

### Example 1

Before the drying step:

| Ingredient | Amount [g] |
|---|---|
| Biomass containing zeaxanthin | 502 (10.8% solids) |
| Gelatin | 31.2 |
| Ascorbyl Palmitate | 1.04 |
| Tocopherol | 2.5 |
| Maltodextrin | 12.6 |

After the drying step (the solid formulation):

| Ingredient | Amount [wt-%] |
|---|---|
| Biomass containing zeaxanthin | 53.39 |
| Gelatin | 30.72 |
| Ascorbyl Palmitate | 1.02 |
| Tocopherol | 2.46 |
| Maltodextrin | 12.41 |

### Example 2

Before the drying step:

| Ingredient | Amount [g] |
|---|---|
| Biomass containing zeaxanthin | 500 (10.8% solids) |
| Calcium Lignosulfonate | 72 |
| Ethoxyquin | 3 |
| Maltodextrin | 12.0 |

After the drying step (the solid formulation):

| Ingredient | Amount [wt-%] |
|---|---|
| Biomass containing zeaxanthin | 38.3 |
| Calcium Lignosulfonate | 51.1 |
| Ethoxyquin | 2.1 |
| Maltodextrin | 8.5 |

### Example 3

Before the drying step:

| Ingredient | Amount [g] |
|---|---|
| Biomass containing acetylated zeaxanthin | 525 (10.3% solids) |
| Calcium Lignosulfonate | 61 |
| Ethoxyquin | 2.55 |
| Maltodextrin | 10.2 |

After the drying step (the solid formulation)

| Ingredient | Amount [wt-%] |
|---|---|
| Biomass containing acetylated zeaxanthin | 42.32 |
| Calcium Lignosulfonate | 47.71 |
| Ethoxyquin | 1.99 |
| Maltodextrin | 7.98 |

### Example 4

Before the drying step:

| Ingredient | Amount [g] |
|---|---|
| Biomass containing zeaxanthin | 1000 (10.8% solids) |
| Calcium Lignosulfonate | 145 |
| Ethoxyquin | 6 |
| Maltodextrin | 25 |

After the drying step (the solid formulation):

| Ingredient | Amount [g] |
|---|---|
| Biomass containing zeaxanthin | 38.0 |
| Calcium Lignosulfonate | 51.1 |
| Ethoxyquin | 2.1 |
| Maltodextrin | 8.8 |

### Example 5

Before the drying step:

| Ingredient | Amount [g] |
|---|---|
| Biomass containing acetylated zeaxanthin | 1010 (10.3% solids) |
| Calcium Lignosulfonate | 145 |
| Ethoxyquin | 6.2 |
| Maltodextrin | 25 |

After the drying step (the solid formulation):

| Ingredient | Amount [wt-%] |
|---|---|
| Biomass containing acetylated zeaxanthin | 37.12 |
| Calcium Lignosulfonate | 51.74 |
| Ethoxyquin | 2.22 |
| Maltodextrin | 8.92 |

All of these formulations are stable as such as well as in a further formulated product. The loss of the carotenoid is less than 20% (after storage of 12 months at 25° C.).

1. A solid formulation comprising
(i) 25 to 75 wt-%, based on the total weight of the solid formulation, of at least one source bioorganism producing carotenoid(s), retinolic compound(s) or other small molecule lipophilic agent(s), and
(ii) 25 to 75 wt-%, based on the total weight of the solid formulation, of at least one hydrocolloid, and
(iii) optionally 0.1 to 10 wt-%, based on the total weight of the solid formulation, of at least one antioxidant and
(iv) optionally 5 to 20 wt-%, based on the total weight of the solid formulation, of at least one auxiliary agent.

2. Solid formulation according to claim 1, wherein the source bioorganism is chosen from the group consisting of animal bioorganism, mammalian bioorganism, insect bioorganism, plant bioorganism, fungal bioorganism, yeast bioorganism, algal bioorganism, bacterial bioorganism, cyanobacterial bioorganism, archaebacterial bioorganism and protozoal bioorganisms.

3. Solid formulation according to claim 1, wherein the source bioorganism is producing a carotenoid which is chosen from the group consisting of antheraxanthin, adonirubin, adonixanthin, astaxanthin, canthaxanthin, capsorubrin, β-cryptoxanthin, α-carotene, β-carotene, β,ψ-carotene, δ-carotene, ε-carotene, echinenone, 3-hydroxyechinenone, 3′-hydroxyechinenone, γ-carotene, ψ-carotene, 4-keto-γ-carotene, ζ-carotene, α-cryptoxanthin, deoxyflexixanthin, diatoxanthin, 7,8-didehydroastaxanthin, didehydrolycopene, fucoxanthin, fucoxanthinol, isorenieratene, β-isorenieratene, lactucaxanthin, lutein, lycopene, mimulaxanthin, myxobactone, neoxanthin, neurosporene, hydroxyneurosporene, peridinin, phytoene, rhodopin, rhodopin glucoside, rhodoxanthin, 4-keto-rubixanthin, siphonaxanthin, spheroidene, spheroidenone, spirilloxanthin, torulene, 4-keto-torulene, 3-hydroxy-4-ketotorulene, uriolide, uriolide acetate, violaxanthin, zeaxanthin-β-diglucoside, zeaxanthin, and C₃₀ carotenoids; as well as derivatives thereof.

4. Solid formulation according to claim 1, wherein the hydrocolloid may be chosen from, but is not limited to the group consisting of agar-agar, carrageenan, gelatin, pectin, xanthan gum, gum arabic, guar gum, locust bean gum, cellulose derivatives as carboxymethyl cellulose, alginate, lignosulfonate, plant proteins (such as soy protein isolate or lupin protein isolates) and starch (also modified starches such as OSA-modified starches.

5. Solid formulation according to claim 1, wherein the formulation comprised 0.1 to 10 wt.-%, based on the total weight of the solid formulation, of at least one antioxidants, chosen from the group including, but not limited to tocopherols, vitamin C, ethoxyquin, vitamin E, BHT, BHA and TBHQ.

6. Solid formulation according to claim 1, wherein the formulation is 5 wt-% to 20 wt-%, based on the total weight of the solid formulation, of at least one auxiliary agent, which useful for the application in the food or feed product by improving the property of these compositions, physical stability, storage stability, visual perception, controlled release in the GI-tract, pH control, etc.

7. Solid formulation according to claim 1, wherein the total content of carotenoid(s), retinolic compound(s) or other small molecule lipophilic agent(s) is up to 20 wt-%, based on the total weight of the solid formulation.

8. A process for the preparation of the solid formulation according to claim 1 comprising the following steps (the specific order of which may be altered):
(a) optionally pasteurizing the harvested fermentation broth;
(b) harvesting the bioorganism from the fermentation broth (e.g. by centrifugation) and re-suspending the bioorganism pellet in an aqueous medium
(c) discarding the supernatant;
(d) optionally resuspending the bioorganism pellet in an aqueous medium and again harvesting the bioorganism
(e) optionally rupturing the bioorganisms (e.g. by milling);
(f) optionally adding at least one antioxidant;
(g) adding at least one hydrocolloid as well as adding optionally at least one auxiliary;
(h) drying the solution.
